(19) United States
(12) Patent Application Publication
(10) Pub. No.: US 2013/0087502 A1
(43) Pub. Date: Apr. 11, 2013

(54) WATER IMPURITY REMOVAL METHODS AND SYSTEMS

(71) Applicants: David J. BLUMER, Bartlesville, OK (US); Ying XU, Bartlesville, OK (US); Bruce B. RANDOLPH, Bartlesville, OK (US); John A. CRUZE, Flat Rock, NC (US)

(72) Inventors: David J. BLUMER, Bartlesville, OK (US); Ying XU, Bartlesville, OK (US); Bruce B. RANDOLPH, Bartlesville, OK (US); John A. CRUZE, Flat Rock, NC (US)

(73) Assignee: CONOCOPHILLIPS COMPANY, Houston, TX (US)

(21) Appl. No.: 13/644,185

(22) Filed: Oct. 3, 2012

Related U.S. Application Data
(60) Provisional application No. 61/544,088, filed on Oct. 6, 2011.

(51) Int. Cl. C02F 1/00; C02F 1/68; C02F 1/463; C02F 1/24; B01D 39/20; C02F 1/72; C02F 1/28; B01D 29/66; B01D 29/62; C02F 1/02; C02F 1/44

(52) U.S. Cl. 210/652; 210/767; 210/747.5; 210/774; 210/708; 205/751; 210/703; 210/758; 210/663; 210/798; 210/797; 210/483; 210/181

(57) ABSTRACT

Methods and systems for enhanced water treatment comprise inorganic filter systems for impurity removal. Embodiments for water impurity removal include introducing contaminated water into an impurity removal system having an inorganic filter. The inorganic filter comprises an inorganic membrane layer supported by an inorganic support. The inorganic membrane layer comprises pores sized from about 1,000 Daltons to about 10 microns for filtering impurities such as kinetic hydrate inhibitor. Other pre-treatment and post-treatment stages may be included. The inorganic membrane layer or inorganic membrane support may comprise a ceramic such as alumina, zirconia, silica, silicon carbide, and mixed oxides. As compared to conventional methods, advantages of certain embodiments include one or more of: higher efficiencies, higher capacities, higher integrity against more aggressive feeds and higher temperatures, increased impurity recyclability, increased product quality, increased automation, increased simplicity, reduced waste, high modularization allowing enhanced scale-up, and lower operational and capital costs.

### CROSS-REFERENCE TO RELATED APPLICATIONS

This application claims benefit of U.S. Patent Application Ser. No. 61/544,088 filed Oct. 6, 2011, entitled “Water Impurity Removal Methods and Systems” and is related to U.S. Patent Application Ser. No. 61/578,298, filed Dec. 21, 2011, entitled “Removal of Field Chemicals from Produced Water Using Different Membrane Processes and System Development,” which is hereby incorporated by reference.

### FIELD OF THE INVENTION

The present invention relates generally to methods and systems for enhanced water treatment. More particularly, but not by way of limitation, embodiments of the present invention include methods and systems for treating water using inorganic filter systems for impurity removal.

### BACKGROUND

In the production of hydrocarbons, water is often produced concurrently with hydrocarbons. Sources of the water include naturally-occurring formation water and water injected into the formation from certain types of treatment operations such as secondary operations for production enhancement (e.g. steam or water floods, formation stimulation, etc).

This water produced from subterranean formations often contains impurities. Any number of natural-occurring or synthetic impurities may be present in the produced water, including, but not limited to, kinetic hydrate inhibitors.

Kinetic hydrate inhibitors (“KHI”) are sometimes added to a hydrocarbon production flow to prevent hydrate formation in the produced hydrocarbons. Clathrate hydrates are crystalline water-based solids physically resembling ice, in which small non-polar molecules (typically gases) are trapped inside “cages” of hydrogen-bonded water molecules. These hydrocarbon clathrates compounds are highly undesirable as they cause flow problems for the petroleum industry. In particular, they have a strong tendency to agglomerate and to adhere to pipe walls and plug pipelines. Hydrate formation is particularly acute in produced hydrocarbons when hot hydrocarbons that exit the sea floor are routed into a production pipeline or riser that is surrounded by cold sea water. The immediate cooling of the hydrocarbons by the surrounding cold water often encourages the formation of these hydrates.

Because hydrate formation is undesirable, hydrocarbon producers often attempt to avoid operating conditions that favor the formation of hydrates. Nevertheless, in those circumstances where hydrate formation cannot be avoided, hydrocarbon producers often attempt to prevent or mitigate hydrate formation in the first place.

Various inhibitors exist for the prevention of hydrate formation, either through the prevention of hydrate nucleation and/or hydrate agglomeration. As mentioned above, one type of hydrate inhibitor that is sometimes used to mitigate the formation of hydrates are kinetic hydrate inhibitors.

Unfortunately, kinetic hydrate inhibitors used during hydrocarbon extraction often contaminate the water that is concurrently produced with the hydrocarbons. Typically, it is desired to dispose of the water after its extraction and separation of the water from the concurrently-produced hydrocarbons. Unfortunately, due to environmental concerns and/or regulations, the presence of these inhibitors often prevents disposal or other uses of the contaminated water. Accordingly, it is desired to remove these inhibitors before disposal of the water. Kinetic hydrate inhibitors are, however, a relatively new means for inhibiting hydrate formation. Therefore, the petroleum industry has comparatively little experience with these inhibitors.

Many conventional methods exist for water impurity removal. Some of the conventional methods include electrocoagulation/flocculation, chemical coagulation, solvent extraction, wet air oxidation, and catalytic wet air oxidation.

Unfortunately, these conventional methods suffer from a variety of disadvantages. Many of the conventional methods are limited to removing only about 30 to 40% of inhibitors from water (e.g. electrocoagulation/flocculation, chemical coagulation, and solvent extraction). This limited removal rate remains unsatisfactory in many situations. Further, this limited removal rate results in wasted kinetic hydrate inhibitor that cannot be recycled for repeated use.

Another common conventional inhibitor removal technique is the use of organic membrane filters. Organic membrane filters are easily damaged however by both physical means (e.g. high transmembrane pressure drops, high velocity particulates which impact and damage the membrane, etc) and chemical means (e.g. highly acidic or caustic solutions or other means of chemical attack). Additionally, organic membranes have rather restricted temperature limitations whereby organic membranes cannot withstand elevated temperatures. This temperature limitation is particularly problematic where removal of kinetic hydrate inhibitor is concerned however, because the solubility of kinetic hydrate inhibitor, unlike most solutes, decreases with increasing temperature. Therefore, this temperature limitation of organic membranes prevents organic membranes from functioning at elevated temperatures where removal of the inhibitor would be optimal, that is, when the solubility of the kinetic hydrate inhibitor is at its lowest.

Moreover, some of the conventional methods chemically alter the kinetic hydrate inhibitor upon removing it from the water (e.g. coagulation, flocculation, and adsorption processes), preventing direct reuse of the kinetic hydrate inhibitor. Also, conventional methods, due to their nature, are often not highly automated and require constant attention for quality control (e.g. adsorption columns and chemical coagulation/flocculation). These processes often suffer from quality control problems. Additionally, some of the conventional methods suffer from overly complicated and/or wasteful cleaning or regeneration requirements. Other conventional methods suffer from severe capacity limitations. In some cases, conventional methods suffer from undue complexity, excessive high capital and/or excessively high operational costs.

Accordingly, there is a need for enhanced water impurity removal methods and systems that address one or more of the disadvantages of the prior art.

### SUMMARY

The present invention relates generally to methods and systems for enhanced water treatment. More particularly, but not by way of limitation, embodiments of the present invention include methods and systems for treating water using inorganic filter systems for impurity removal.

One example of a method for removal of impurities from produced water comprises the steps of: introducing the impurities into a production flow, wherein the impurities comprise a kinetic hydrate inhibitor, wherein the production flow comprises hydrocarbons and a produced water; separating the produced water from the production flow; introducing the produced water to an impurity removal system, wherein the impurity removal system comprises a ceramic membrane crossflow filter, wherein the ceramic membrane crossflow filter comprises a plurality of pores, the pores having pore sizes from about 1,000 Daltons to about 2 microns; allowing the impurity removal system to separate the impurities from the produced water to form a permeate and a retentate, wherein the retentate is enriched with the kinetic hydrate inhibitor; disposing the permeate to the environment; recycling or disposing of at least a portion of the recovered kinetic hydrate inhibitor.

One example of a method for water purification comprises the steps of: introducing a produced water to one or more impurity removal systems, wherein each of the one or more impurity removal systems comprises an inorganic filter, wherein the inorganic filter comprises an inorganic membrane layer and an inorganic membrane support, wherein the produced water comprises a kinetic hydrate inhibitor, wherein the inorganic membrane layer comprises a plurality of pores, the pores having pore sizes of from about 1,000 Daltons to about 10 microns; and allowing the impurity removal system to separate the kinetic hydrate inhibitor from the produced water to form a permeate and a retentate, wherein the retentate is enriched with the kinetic hydrate inhibitor to form a recovered kinetic hydrate inhibitor.

One example of a water impurity removal system for KHI removal from an aqueous stream comprises: a ceramic membrane crossflow filter, wherein the ceramic membrane crossflow filter comprises a plurality of pores, the pores having pore sizes from about 1,000 Daltons to about 2 microns; wherein the ceramic membrane crossflow filter comprises an inorganic support and a ceramic membrane layer wherein the inorganic support interfaces with the ceramic membrane layer by providing support for the ceramic membrane layer; wherein the ceramic membrane crossflow filter has a feed inlet, a permeate outlet, and a retentate outlet; and wherein the ceramic membrane crossflow filter is adapted to accept a contaminated water wherein the contaminated water comprises KHI.

The features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 illustrates an example of a water impurity removal system in accordance with one embodiment of the present invention.

FIG. 2 illustrates an example of an inorganic crossflow filter in accordance with one embodiment of the present invention.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The present invention relates generally to methods and systems for enhanced water treatment. More particularly, but not by way of limitation, embodiments of the present invention include methods and systems for treating water using inorganic filter systems for impurity removal.

In certain embodiments, methods and systems for water impurity removal include introducing contaminated water into an impurity removal system. The impurity removal system comprises an inorganic filter. The inorganic filter may comprise an inorganic membrane layer supported by an inorganic support. The inorganic membrane layer comprises pores sized from about 1,000 Daltons to about 10 microns for filtering impurities from the contaminated water. One example of an impurity that may be removed by this filter is kinetic hydrate inhibitor. In certain embodiments, the impurity removal system may comprise one or more impurity removal stages. In some cases, the inorganic membrane layer and/or inorganic membrane support comprises a ceramic such as alumina, zirconia, silica as well as silicon carbide, and mixed oxides.

As compared to many conventional methods, advantages of certain embodiments of the water impurity removal methods and systems described herein include, but are not limited to, one or more of the following:
higher efficiencies,
higher capacities,
the ability to withstand more aggressive feeds (e.g. highly acidic or caustic feeds),
the ability to withstand higher temperatures,
an increased recyclability of a removed impurity such as an inhibitor by avoiding alteration of the impurity during the removal process,
increased product quality,
more highly automated processes,
more simplified and less wasteful cleaning processes,
high modularization, allowing for ease of scale-up and additional capacity, and
lower operational and capital costs.
   Other advantages will be apparent from the disclosure herein.

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

Although the following examples are described with reference to the impurities being kinetic hydrate inhibitor, it is recognized that the following examples may be applied to other impurities which may be found in produced water.

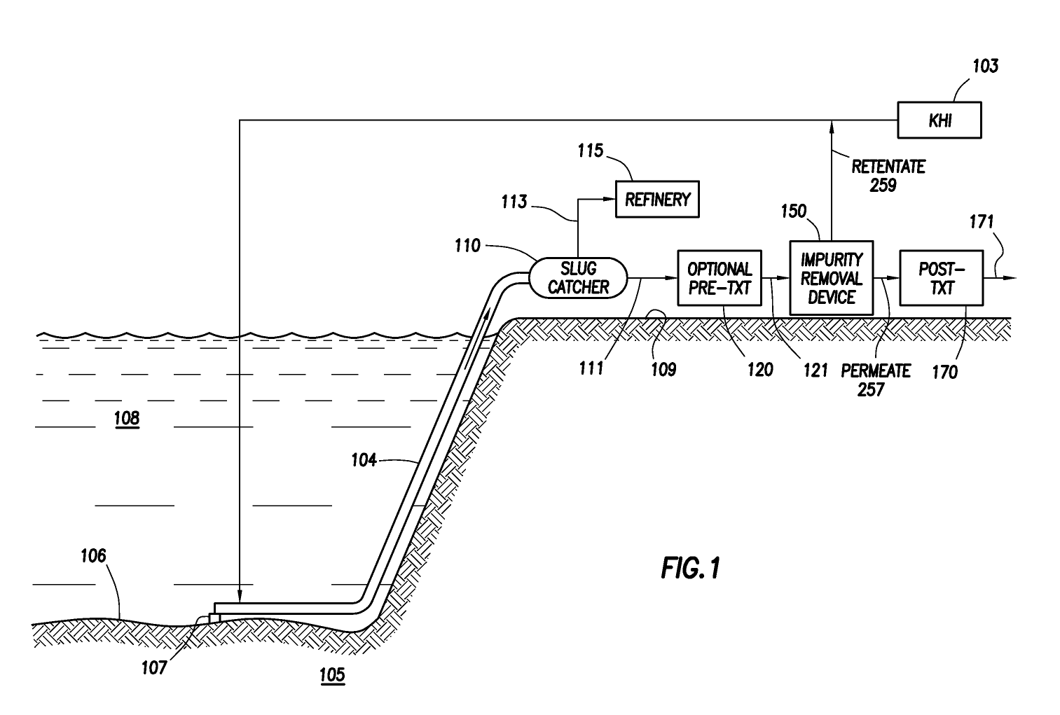

FIG. 1 illustrates an example of a water impurity removal system in accordance with one embodiment of the present invention. In this example, hydrocarbons, such as natural gas, are produced from subterranean formation 105 at wellhead 107. Hydrocarbons produced from subterranean formation 105 are transported via production pipeline 104 to surface 109 along with any water that may be produced along with the desired hydrocarbons. As used herein, the term “produced water” refers to any water that is produced concurrently with subsurface hydrocarbons, whether or not subsequently separated from the extracted hydrocarbons.

As production pipeline 104 is surrounded by cold sea water 108, any production flow leaving subterranean formation 105 may experience cooling as the production flow is transported to surface 109. Under some conditions, undesirable hydrates may form in the production flow as it is cooled upon leaving subterranean formation 105 and entering production pipeline 104, which is surrounded by cold sea water 108. One way of inhibiting hydrate formation is by introducing kinetic hydrate inhibitor into production pipeline 104 via inhibitor injection line 103. Kinetic hydrate inhibitors function by slowing down the kinetics of the nucleation of hydrate molecules.

The hydrocarbon/water mixture produced from subterranean formation 105 is transported to separator 110 at surface 109. Separator 110 is any device suitable for separating the water from the hydrocarbons. Examples of suitable separators include, but are not limited to, flash drums, centrifuges, slug catchers, or any combination thereof. Separated hydrocarbons 113 are routed via line 115 for subsequent treatment, separation, and/or transport to terminals for sale. Produced water 111, which comprises the water separated from the production flow, flows to optional pretreatment step 120.

Optional pretreatment step 120 is any pretreatment of produced water 111 suitable for preparing produced water 111 for impurity removal device 150, including, but not limited to, removal of relatively large particulates, pretreatment with a surfactant, with coagulant/flocculents, with an electrocoagulant, with a floatation unit, with other chemical, physical, or electrical aids (e.g. to grow, agglomerate, or adsorb/adsorb the molecules/particles), with steam destruction, or any combination thereof.

In certain embodiments, pretreatment step 120 comprises a temperature adjustment to produced water 111. Increasing the temperature of produced water 111 may increase the effectiveness of impurity removal device 150 since kinetic hydrate inhibitor, unlike most other conventional solutes, happens to increase in particle size due to agglomeration of the kinetic hydrate inhibitor particles as the temperature increases. Increasing the particulate size of kinetic hydrate inhibitor is beneficial in that larger kinetic hydrate inhibitor particles are more easily separated from produced water 111. In certain embodiments, the temperature of produced water 111 may be increased up to about 90° C. before introducing produced water 111 to impurity removal device 150.

In some embodiments, no pretreatment step is performed prior to the introduction of produced water to impurity removal device 150. The avoidance of an optional pretreatment step can be advantageous by avoiding additional capital costs. Where chemical treatment is avoided before impurity removal device 150, significant chemical waste may be avoided in addition to lowering operating costs attributable to such a pretreatment step.

After pretreatment step 120, pretreated produced water 121, is introduced to impurity removal device 150. Impurity removal device 150 comprises an inorganic filter. The inorganic filter comprises pores having pore sizes tailored to specifically target kinetic hydrate inhibitor molecules. Molecular weight cut-off (MWCO) is a term sometimes used to describe membrane pore size. The smaller the MWCO, the tighter the membrane pore size. MWCO is typically measured in Daltons which refers to the molecular weight cut-off of a given pore size. For example, pore sizes with an average molecular weight cut-off of 1,000 Daltons will reject molecules with an average molecular weight of about 1,000 well (i.e. typically greater than about 90% rejection rate). In certain embodiments, the pore sizes may range from 1,000 Daltons to about 8,000 Daltons or in some embodiments, more broadly from about 1,000 Daltons to about 10 microns. In some embodiments, the average pore size is less than about 10 microns or less than about 8,000 Daltons. In other embodiments, at least about 75% of the pores have a pore size less than about 2 microns. In yet other embodiments, about 50% to about 90% of the pores have a pore size less than about 0.005 microns.

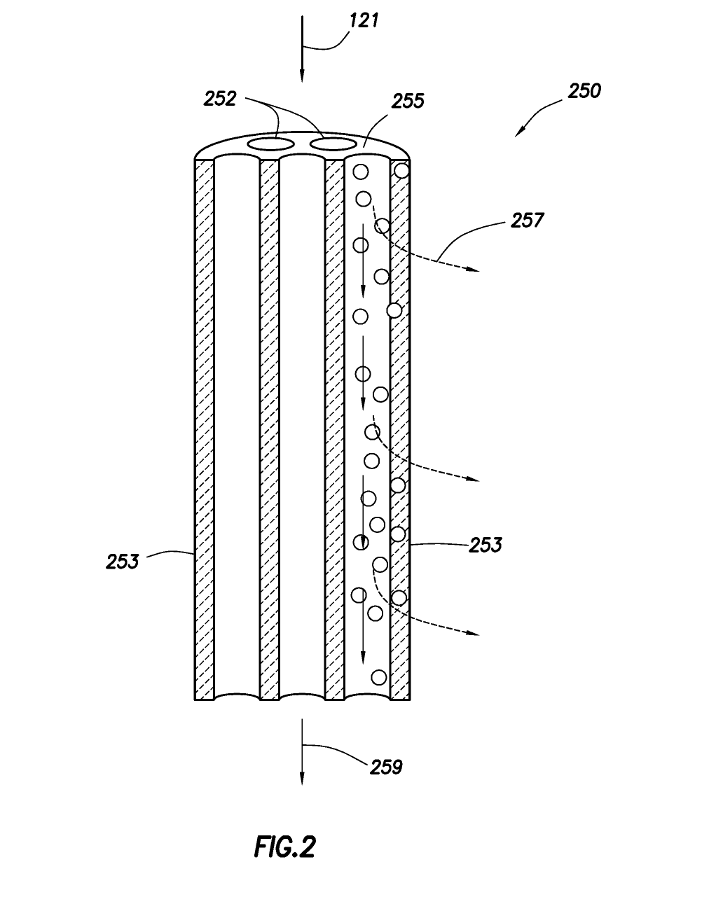

Impurity removal device 150 may be configured as a cross-flow filter or a dead-end filter. FIG. 2 illustrates a more detailed view of a cross-flow filter. Turning to FIG. 2, impurity removal device 250 is depicted in a cross-flow configuration. Here, impurity removal device 250 may further comprise inorganic support 255 and inorganic membrane layer 253. The inorganic membrane layer functions as the selective layer, whereas the inorganic support functions to provide structural support upon which the membrane layer may be supported. Here, inorganic support 255 is depicted in an overall cylinder shape having channels 252 therethrough. Although inorganic support 255 is depicted as cylindrical in shape, it is recognized that inorganic support 255 could be formed in any number of shapes, and the shape depicted here is not intended to be limiting.

Pretreated produced water 121 (or produced water 111 where no pretreatment step 120 is present) flows through impurity removal device 250 by way of channels 252. Inorganic membrane layer 253, which in this case, surrounds inorganic support 252, allows fluid to pass through inorganic membrane layer 253 but rejects particulates greater than the pore sizes of inorganic membrane layer 253. The fluid passing through inorganic membrane layer 253 and then through structural support 255 is referred to as permeate 257 whereas the fluid exiting channels 252 (along with any particulates retained therein) is referred to as retentate 259. Due to the selectivity of inorganic membrane layer 253, permeate 257 is substantially depleted in kinetic hydrate inhibitor, whereas retentate 259 becomes enriched in the kinetic hydrate inhibitor.

In certain embodiments, the inorganic support layer may comprise any metal such as stainless steel or any ceramic, such as a silicon carbide support. The ceramic membrane layer may comprise any inorganic material including metals (such as stainless stell), ceramics, or inorganic layers having chemically-modified surfaces. Examples of suitable ceramic membrane layers include, but are not limited to, silicon carbide membrane layer, a silicon dioxide membrane layer, an aluminum oxide membrane layer, a titanium dioxide membrane layer, a zirconium oxide membrane layer, alumina, zirconia, titania, silicon carbide, or any combination thereof.

Unlike conventional organic filters, the inorganic filter (e.g. ceramic filters) benefit from a number of advantages, including enhanced structural integrity, strength, durability, heat resistance, chemical resistance, extreme pH resistance, and higher fluxes. Conventional organic filters often suffer from susceptibility to one or more limitations such as physical damage from high pressures or high velocity flows (including due to high velocity particulates), chemical attack, or susceptibility to highly acidic or caustic solutions. Unlike conventional devices, the material of construction of certain embodiments of the impurity removal devices of the present invention may permit more aggressive feeds to the device, including, but not limited to, feeds having pH ranges from less than about 2 or greater than about 14, feeds having fluxes from about 20 liters/m²/hr to about 150 liters/m²/hr, feeds having temperatures greater than about 90° C. (as limited by sealing, glue, piping, housing materials), feeds having organic contents greater than about 100 ppm, feeds having hydrogen sulfide concentrations greater than about 220 ppm, feeds having total dissolved solid concentrations greater than about 100 ppm, feeds having pressures from about 50 psi to about 120 psi, or any combination thereof. In certain embodiments, impurity removal devices of the present invention allow feeds comprising one or more combinations of the following components: non-trivial concentration of organic matters, hydrogen sulfide, and relatively high level of suspended solids. The increased robustness of material of construction of the inorganic impurity removal devices described herein additionally results in longer life device spans.

Cleaning of the inorganic impurity removal devices is simplified as well due in part to the more robust material of construction of inorganic impurity removal device. Examples of suitable cleaning steps that may be employed with the devices of the present invention include, but are not limited to steam cleaning, acid or caustic washes, high velocity back-flushing, flushing with a cleaning solution (e.g. surfactants such as sodium dodecyl sulfate), cleaning with a solvent, or any combination thereof.

The increased robustness also translates into the devices being able to handle higher transmembrane pressures. Examples of suitable transmembrane pressures include, but are not limited, to pressures up to about 150 psi.

Returning to FIG. 1, after treatment by impurity removal device 150, Permeate 257, which comprises mostly water, flows to optional post-treatment step 170. Post-treatment step 170 may comprise any treatment that provides additional impurity removal or which further prepares permeate 257 for disposal to the environment or to a subsequent application. Examples of suitable post-treatment steps 170 include, but are not limited to, post-treating the produced water with a reverse-osmosis polishing step, with another filtration step, with steam destruction, with chemical oxidation, with an extraction step, with an adsorption process, or any combination thereof.

In certain embodiments, impurity removal systems of the present invention may remove up to about 90% of kinetic hydrate inhibitor present in produced water and in some embodiments up to about 50%. Once the concentration of kinetic hydrate inhibitor has been reduced to a desired level, the treated water may be disposed of to the environment or recycled for another use.

It is recognized that any of the elements and features of each of the devices described herein are capable of use with any of the other devices described herein without limitation. Furthermore, it is recognized that the steps of the methods herein may be performed in any order except unless explicitly stated otherwise or inherently required otherwise by the particular method.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations and equivalents are considered within the scope and spirit of the present invention. Also, the terms in the claims have their plain, ordinary meaning unless otherwise explicitly and clearly defined by the patentee.

What is claimed is:

1. A method for removal of impurities from produced water comprising the steps of:
introducing the impurities into a production flow, wherein the impurities comprise a kinetic hydrate inhibitor, wherein the production flow comprises hydrocarbons and a produced water;
separating the produced water from the production flow;
introducing the produced water to an impurity removal system, wherein the impurity removal system comprises a ceramic membrane crossflow filter, wherein the ceramic membrane crossflow filter comprises a plurality of pores, the pores having pore sizes from about 1,000 Daltons to about 2 microns;
allowing the impurity removal system to separate the impurities from the produced water to form a permeate and a retentate, wherein the retentate is enriched with the kinetic hydrate inhibitor;
disposing the permeate to the environment;
recycling or disposing of at least a portion of the recovered kinetic hydrate inhibitor.

2. The method of claim 1 wherein the step of introducing the impurities into the production flow further comprises the step of introducing the impurities into the production flow at an injection point in a production pipeline in proximity to a sea floor from which the production flow is extracted.

3. The method of claim 2 wherein the step of separating the produced water from the production flow further comprises the step of separating the produced water from the production flow using a slug catcher, wherein the hydrocarbons comprise a gas.

4. The method of claim 1 wherein no chemical treatment of the produced water is performed prior to the step of introducing the produced water to the impurity removal system.

5. The method of claim 1 further comprising the step of increasing the temperature of the produced water prior to the step of introducing the produced water to an impurity removal system.

6. The method of claim 1 further comprising the step of pretreating the produced water prior to the step of introducing the produced water to the impurity removal system.

7. The method of claim 6 wherein the step of pretreating the produced water is the step of pretreating the produced water with a surfactant, pretreating the produced water with a coagulant, pretreating the produced water with an electrocoagulant, pretreating the produced water with a floatation unit, pretreating the produced water with other chemical, physical, or electrical aids, pretreating the produced water with steam destruction, pretreating the produced water via a temperature adjustment of the produced water, or any combination thereof.

8. The method of claim 1 further comprising the step of post-treating the produced water after the step of introducing the produced water to the impurity removal system.

9. The method of claim 8 wherein the step of post-treating the produced water is the step of post-treating the produced water with a reverse-osmosis polishing step, post-treating the produced water with another filtration step, post-treating the produced water with steam destruction, post-treating the produced water with chemical oxidation, treating the produced water with an extraction step, post-treating the produced water with an adsorption process, or any combination thereof.

10. The method of claim 1 wherein the step of disposing the permeate to the environment further comprises the step of disposing the permeate to a disposal well.

11. The method of claim 1 wherein the pores have an average pore size of less than about 10 microns.

12. The method of claim 1 wherein the pores have an average pore size of from about 0.001 microns to about 0.005 microns

13. The method of claim 1 wherein the pores are sized to have a molecular weight cutoff (MWCO) of less than about 300,000 Daltons.

14. The method of claim 1 wherein the ceramic membrane crossflow filter comprises an inorganic support and a ceramic membrane layer wherein the inorganic support interfaces with the ceramic membrane layer by providing support for the ceramic membrane layer.

15. The method of claim 14 wherein the ceramic membrane layer comprises pores wherein the pores are sized to have molecular weight cutoff (MWCO) from about 1,000 Daltons to about 8,000 Daltons.

16. The method of claim 15 wherein the inorganic support is a ceramic support, a silicon carbide support, or any combination thereof.

17. The method of claim 15 wherein the ceramic membrane layer is silicon carbide membrane layer, a silicon dioxide membrane layer, an aluminum oxide membrane layer, a titanium dioxide membrane layer, a zirconium oxide membrane layer, or any combination thereof.

18. The method of claim 1 further comprising the step of cleaning the impurity removal system by backflushing the impurity removal system with a cleaning solution or a solvent.

19. The method of claim 18 wherein the cleaning solution comprises diethylene glycol monoethyl ether.

20. The method of claim 1 further comprising the step of cleaning the impurity removal system by treating the impurity removal system with a surfactant wherein the surfactant comprises sodium dodecyl sulfate.

21. The method of claim 1 further comprising the step of cleaning the impurity removal system by steam treatment of the impurity removal system.

22. The method of claim 1 wherein the impurity removal system achieves a kinetic hydrate inhibitor removal rate greater than about 50%.

23. The method of claim 1 wherein the produced water comprises a contaminant, wherein the contaminant is hydrocarbons at a concentration in the produced water of at least 100 ppm, hydrogen sulfide at a concentration in the produced water of at least 220 ppm, a total dissolved solids at a concentration in the produced water of at least 100 ppm, or any combination thereof.

24. The method of claim 1 wherein the produced water is at a pH less than about 4 or greater than about 9.

25. The method of claim 1 wherein the produced water is at a temperature greater than about 90° C. during the step of introducing the produced water to the impurity removal system.

26. The method of claim 1 wherein the impurity removal system can withstand a transmembrane pressure from about 50 psi to about to about 120 psi.

27. A method for water purification comprising the steps of:
introducing a produced water to one or more impurity removal systems, wherein each of the one or more impurity removal systems comprises an inorganic filter, wherein the inorganic filter comprises an inorganic membrane layer and an inorganic membrane support, wherein the produced water comprises a kinetic hydrate inhibitor, wherein the inorganic membrane layer comprises a plurality of pores, the pores having pore sizes of from about 1,000 Daltons to about 10 microns; and
allowing the impurity removal system to separate the kinetic hydrate inhibitor from the produced water to form a permeate and a retentate, wherein the retentate is enriched with the kinetic hydrate inhibitor to form a recovered kinetic hydrate inhibitor.

28. The method of claim 1 further comprising the steps of:
introducing the kinetic hydrate inhibitor into a production flow wherein the production flow comprises hydrocarbons and water;
recycling at least a portion of the recovered kinetic hydrate inhibitor; and
disposing the permeate to the environment.

29. The method of claim 1 wherein the one or more impurity removal systems comprises a first stage and a second stage, wherein the inorganic membrane layer of the first stage comprise pores having pore sizes from about 0.005 microns to about 10 microns and wherein the inorganic membrane layer of the second stage comprise pores having pore sizes of about 1,000 Daltons to about 50,000 Daltons.

30. The method of claim 1 wherein the inorganic layer and the inorganic membrane possesses sufficient structural integrity to withstand fluxes from about 20 to about 150 liters/m²/hr.

31. The method of claim 1 wherein the inorganic filter comprises a crossflow filter.

32. The method of claim 1 wherein the inorganic filter comprises a dead-end filter.

33. A water impurity removal system for KHI removal from an aqueous stream comprising:
a ceramic membrane crossflow filter, wherein the ceramic membrane crossflow filter comprises a plurality of pores, the pores having pore sizes from about 1,000 Daltons to about 2 microns;
wherein the ceramic membrane crossflow filter comprises an inorganic support and a ceramic membrane layer wherein the inorganic support interfaces with the ceramic membrane layer by providing support for the ceramic membrane layer;
wherein the ceramic membrane crossflow filter has a feed inlet, a permeate outlet, and a retentate outlet; and
wherein the ceramic membrane crossflow filter is adapted to accept a contaminated water wherein the contaminated water comprises KHI.

34. The water impurity removal system of claim 33 further comprising a heater, wherein the heater has an inlet and an outlet, wherein the outlet of the heater is in fluid communication with the feed inlet of the ceramic membrane crossflow filter, wherein the heater is adapted to heat a contaminated water upstream of the ceramic membrane crossflow filter.
